(19) United States
(12) Patent Application Publication
(10) Pub. No.: US 2011/0222959 A1
(43) Pub. Date: Sep. 15, 2011

(54) JOINT AND/OR MOUNT ARRANGEMENT

(75) Inventors: Olaf Beutler, Diepholz (DE); Ulrich Bladt, Ibbenburen (DE); Dirk Stuntebeck, Steinfeld (DE)

(73) Assignee: ZF Friedrichshafen AG, Friedrichshafen (DE)

(21) Appl. No.: 12/673,184

(22) PCT Filed: Jul. 30, 2008
(86) PCT No.: PCT/DE2008/050017

§ 371 Date: Feb. 12, 2010

(30) Foreign Application Priority Data
Aug. 14, 2007 (DE) 10 2007 038 491.4

(51) Int. Cl. F16C 11/06

(52) U.S. Cl. 403/122

(57) ABSTRACT

A joint or bearing arrangement (1) comprises a pivot pin (2) whose head region (3) is movably mounted in a joint shell (5) accommodated in a housing (4). The joint shell (5) and the housing (4) have a through opening (6) for the pivot pin (2). The through opening (6) is sealed against the exterior environment by a sealing sleeve (7) resting against the pivot pin (2) and molded to the joint shell (4) by a firmly bonded connection, thus forming a unit with the joint shell (5). The sealing sleeve (7) consists of a soft elastic silicone.

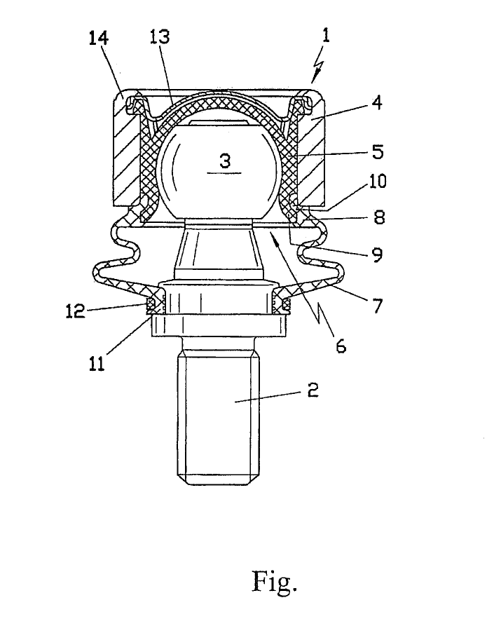

This application is a National Stage completion of PCT/DE2008/050017 filed Jul. 30, 2008, which claims priority from German patent application serial no. 10 2007 038 491.4 filed Aug. 14, 2007.

### FIELD OF THE INVENTION

The invention relates to a joint and/or bearing arrangement.

### BACKGROUND OF THE INVENTION

In joint arrangements which have a pivot pin and whose head region is movably mounted in a joint shell and the joint shell, in turn, is accommodated in a housing and is also secured therein against extraction, the problem is that the joint arrangement has to be sealed for protection against the penetration of moisture or impurities into the interior of the joint and to prevent leakage of lubricant. For this purpose, sealing sleeves are used which seal the through opening provided in the housing for the passage of the pivot pin. The sealing sleeve, on the one hand, rests against the pivot pin and, on the other hand, against the bearing shell or against the housing. To improve the sealing effect, the edge region of the sealing sleeve is secured with a clamp ring in the prior art.

Moreover, from DE 297 21 050 U1 the sealing sleeve is molded to the joint shell in the prior art. The firmly bonded connection between the joint shell and sealing sleeve produced, for example, by molding or spraying, indeed offers significant advantages over the positive attachment, or over the previously mentioned clamp ring attachment, but with the design disclosed in DE 297 21 050 U1 it is still possible that moisture and impurities will penetrate into the region between the bearing shell and housing, in particular during vibrations, since this region is not sealed by the sealing sleeve. However, absolute tightness of the joint and/or bearing arrangement cannot be attained in this manner. Furthermore, in designs like those known from the above publication there is a tendency that the sealing sleeve detaches from the joint shell. The reason for this is that the sealing sleeve tightly mounted to or molded to the joint shell, has to compensate not only for tensile and compression stresses caused by the pivoting of the pivot pin, but also for torsional movements generated by the rotation of the pivot pin about its longitudinal central axis. Since the stresses on the sealing sleeve are not only sequential, but also superimposed, and the sealing sleeve made of polyurethane is relatively rigid, i.e. resists those stresses due to its low elasticity, this can cause the sealing sleeve to detach from the joint shell after a certain time. It was found that the properties of the previously used polyurethane particularly change at low temperatures, with a further reduction in elasticity, which additionally enhances the effect described above.

### SUMMARY OF THE INVENTION

The underlying object of the invention is to produce a joint and/or bearing arrangement whose sealing against the environment is improved in comparison to the designs known from the prior art.

A joint and/or bearing arrangement with a pivot pin whose head region is movably mounted in a joint shell accommodated in a housing, wherein the joint shell and the housing have a through opening for the pivot pin, the opening being sealed against the environment by a sealing sleeve resting against the pivot pin and molded to the joint shell by means of a firmly bonded connection and thus forming a unit with the joint shell, is improved according to the present invention in that the sealing sleeve consists of a soft elastic silicone.

With this invention the disadvantages of previous joint and/or bearing arrangements known from the prior art are avoided. In particular, complex mounting of the sealing sleeve, or providing complicated geometries which allow a positive connection between the sealing sleeve and joint shell, or between the sealing sleeve and housing is no longer necessary. As a result of the silicone material used for the production of the sealing sleeve, and due to the advantageous material properties of silicone, this sleeve is capable of compensating for the required stresses and tracking the movements of the pivot pin without any leaks occurring in the joint and/or bearing arrangement. Silicones are of course water-repellent, electrical insulators, and resistant to oxidizing agents and acids. Furthermore, silicones are weather-, ozone-, UV- and heat-resistant, hydrophobic, have dielectric properties, and are considered to be physiologically compatible. These properties and in particular the wide range of temperature between −40 C and +125° C. within which the material has stable properties, allow its use for joint and/or bearing arrangements in motor vehicles, for example. Manufacturing the sealing sleeve is also easier in comparison to the polyurethane designs, since silicone, due to its higher elasticity, is easier to remove from the injection mold. The range of applications of the silicone sealing sleeve is thus very versatile.

According to a first embodiment of the invention, it is proposed that the sealing sleeve is manufactured of liquid silicone rubber (LSR). Thus, it can be easily manufactured, for example, by means of injection molding. Liquid silicone rubber has at least approx. 70% linear siloxanes, approx. 30% fillers and approx. 1% additives. Electrically conductive types, fluorosilicone types, oil exuding silicones and fast curing types are available, which can each be used depending on the desired results.

For example, it may be intended to use electrically conductive silicones in sealing sleeves for shunting electrostatic charges in joint and/or bearing arrangements in motor vehicles, which is becoming increasingly important due to the increasing number of electronic components and their associated susceptibility to failure due to uncontrolled electric discharges. The electronic components may in fact be destroyed due to these discharges. The charges under discussion which form in a motor vehicle as a result of the friction between tires and road surface, or by movements of the plastic parts present in the motor vehicle, for example, discharge in an uncontrolled manner when the voltage reaches a limit value. As already mentioned above, these voltage overloads can damage electronic components.

It is important for the joint and/or bearing arrangement that a strong bonding connection is created between the joint shell and the sealing sleeve. For this purpose, polyamide is a particularly suitable material for the joint shell. Polyamide is capable of permanently and securely ensuring the adhesive bond to the sealing sleeve, and as such has the characteristics required for the bearing. In addition, it can be easily combined with other substances and its properties can thus be specifically modified.

The combination of a sealing sleeve made of GE Bayer LIM 9071 and a joint shell of Lanxess Durethane BKV 30 black (PA6GF30) is seen as a particularly advantageous material pairing for the joint and/or bearing arrangement according to the present invention.

As already mentioned above in connection with the explanation of the prior art, not only the component connection between the sealing sleeve and joint shell may be of decisive importance for an optimum sealing of the components of a joint and/or bearing arrangement that are movable with respect to one another against the environment. In fact, the insertion of the joint shell into a receiving housing plays an important role. In order to also seal the critical region between the joint shell and housing, it is therefore proposed that the sealing sleeve has an edge section which rests tightly against the housing in the region of the through opening. In this case, contact of the edge section with the corresponding housing is possible by the partial deformation of the edge section. The deformation is possible without significant effort, since the employed silicone is deformable. Moreover, a firmly bonded connection can also be provided here.

Another embodiment of the principle of the invention consists in that the edge section of the sealing sleeve has a contact surface molded complementary to the region of the through opening of the housing. Thus, the edge section of the sealing sleeve rests in an optimum manner against the matching region of the housing.

Another advantageous embodiment of the invention is based on the fact that the joint shell has a support area in the region of the through opening for the pivot pin pointing away from the housing and engaged from the outside by the sealing sleeve. With a design of this kind a strain relief can also be ensured for the sealing sleeve. In addition, the adhesion between the sealing sleeve and joint shell is considerably improved. Accordingly, the joint shell has a retaining area at the through opening for the pivot pin, where the area has an axial component pointing away from the housing and is radially outwardly gripped by the sealing sleeve, a radially outward-acting force can be applied to the edge of the sealing sleeve in the direction of the housing. In particular, a combined stepped axial as well as a radial contact of the edge region of the sealing sleeve with the housing can be available for good sealing. The reliability of the sealing contact is thus additionally improved.

To improve the seat of the joint shell in the housing, the joint shell can further have rings molded on the outer surface thereof in contact with the housing and can be pressed into the housing. These molded-on rings can be designed, for example, as ribs of different geometries.

### BRIEF DESCRIPTION OF THE DRAWINGS

The invention will be explained in more detail below with reference to the attached drawing. The illustrated exemplary embodiment is not limited to the illustrated variant, but will only explain the principle of the invention. In order to be able to illustrate the operating mode according to the present invention, the figure only shows a highly schematic diagram in which components not essential to the invention were dispensed with. This, however, does not mean that such components are not present in the design according to the present invention.

The drawing shows:

The sole FIGURE is a joint and/or bearing arrangement in the form of a ball joint for use in a motor vehicle.

### DETAILED DESCRIPTION OF THE PREFERRED EMBODIMENTS

The joint and/or bearing arrangement 1 illustrated in the exemplary embodiment comprises a pivot pin 2 with a head region 3 configured as a joint ball. The joint and/or bearing arrangement is a ball joint as it is used, for example, for wheel suspensions in motor vehicles. The joint ball 3 is rotatably and tiltably accommodated in a joint shell 5. At the outer surface of the joint shell 5 there are molded-on rings (not visible in the figure) in the shape of ribs, so that the press fit between the joint shell 5 and the receiving housing 4 form a seal against the environment due to the partial deformation of the molded-on ring that occurs when the joint shell 5 is pressed into the housing 4. The portion of the pivot pin 2 protruding from the housing 4 extends through the through opening 6 of the joint shell 5 and the housing 4. To seal the inner joint components against the environment, the joint and/or bearing arrangement 1 shown in the figure has a sealing sleeve 7. This sealing sleeve 7 consists of silicone and is configured like a bellows. Therefore, according to the invention it is very soft and elastic, and has two edge sections 8 and 11. The edge section 11 of the sealing sleeve 7 resting against the pivot pin 2 is pressed in a conventional manner in the centripetal direction by a clamp ring 12 under tension against the contact surface at the pivot pin 2, so that a seal is created.

An edge section 8 is molded on the sealing sleeve 7 on the opposite side thereof which is in contact with the interior of the joint at a specially configured support area 9 of the joint shell 5. The support area 9 has an undercut into which the edge section 8 of the sealing sleeve 7 is embedded.

On the side of the housing, the edge section 8 of the sealing sleeve 7 is provided with a geometry that is complementary to the contour of the housing. The edge section 8 of the sealing sleeve 7 has an axially and a radially outward pointing component here, so that the edge section 8 of the sealing sleeve 7 optimally rests with its contact surface 10 against the corresponding housing contour. Due to the press fit of the joint shell 5 in the housing 4, the edge section 8 of the sealing sleeve 7 is at the same time pressed in between the housing 4 and support area 9 of the joint shell 5 and thus seals this region of the joint and/or bearing arrangement 1.

The ball joint shown in the figure has a housing 4 originally open on both sides. To seal the side of the housing 4 opposite the sealing sleeve 7, the joint shell 5 has a dome-like closed base region. Furthermore, this opening is closed by a cover 13 which is fixed in place in the housing 5 by means of a deformation region 14.

### Reference Numerals

1 Joint and/or bearing arrangement

2 Pivot pin

3 Head region

4 Housing

5 Joint shell

6 Through opening

7 Sealing sleeve

8 Edge section of the sealing sleeve

9 Support area of the joint shell

10 Contact surface of the sealing sleeve

11 Edge section of the sealing sleeve

12 Clamp ring

13 Cover

14 Deformation region

1-9. (canceled)

10. A joint or bearing arrangement (1) with a pivot pin (2) whose head region (3) is movably mounted in a joint shell (5) accommodated in a housing (4), the joint shell (5) and the housing (4) having a through opening (6) for the pivot pin (2), the opening being sealed with respect to an exterior environment by a sealing sleeve (7) resting against the pivot pin (2) and bonded to the joint shell (5) thus forming a unitary unit with the joint shell (5), and the sealing sleeve (7) comprising a soft elastic silicone.

11. The joint or bearing arrangement (1) according to claim 10, wherein the sealing sleeve (7) is manufactured of liquid silicone rubber (LSR).

12. The joint or bearing arrangement (1) according to claim 10, wherein the sealing sleeve (7) is manufactured of an electrically conductive silicone.

13. The joint or bearing arrangement (1) according to claim 10, wherein the joint shell (5) is manufactured of a polyamide material.

14. The joint or bearing arrangement (1) according to claim 10, wherein the sealing sleeve (7) consists of GE Bayer LIM 9071 and the joint shell (5) consists of Lanxess Durethane BKV 30 black (PA6GF30).

15. The joint or bearing arrangement (1) according to claim 10, wherein the sealing sleeve (7) has an edge section (8) which rests against and seals the housing (4) in a region adjacent the through opening (6).

16. The joint or bearing arrangement (1) according to claim 15, wherein the edge section (8) of the sealing sleeve (7) has a contact surface (10) molded complementary to the region of the through opening (6) of the housing (4).

17. The joint or bearing arrangement (1) according to claim 10, wherein the joint shell (5) has a support area (9) in a region of the through opening (6) for the pivot pin (2) pointing away from the housing (4) and engaged from the outside by the sealing sleeve (7).

18. The joint or bearing arrangement (1) according to claim 10, wherein at the outer surface of the joint shell (5) has molded-on rings which contact with the housing (4) and are pressed into the housing (4).

19. A joint or bearing arrangement (1) comprising:
a pivot pin (2) comprising a head region (3), the head region (3) being pivotally and rotationally accommodated within a joint shell (5) which is accommodated within a housing (4), the joint shell (5) and the housing (4) defining a through opening (6) through which the pivot pin (2) passes as the pivot pin (2) extends from the joint shell (5) and the housing (4), the through opening (6) being sealed against a surrounding environment by a sealing sleeve (7), an interior surface of the sealing sleeve (7) is coupled to an outer circumference of the pivot pin (2), at one end thereof, and an opposite end of the sealing sleeve (7) mates with a surface of the housing (4) and is sealingly sandwiched between the joint shell (5) and the housing (4), and the sealing sleeve (7) comprises an elastic silicone.
